(19) United States
(12) Patent Application Publication
(10) Pub. No.: US 2025/0118286 A1
(43) Pub. Date: Apr. 10, 2025

(54) SYNTHESIZING SPEECH IN MULTIPLE LANGUAGES IN CONVERSATIONAL AI SYSTEMS AND APPLICATIONS

(71) Applicant: NVIDIA Corporation, Santa Clara, CA (US)

(72) Inventors: Rohan Badlani, San Jose, CA (US); José Rafael Valle Gomves da Costa, Santa Clara, CA (US); Kevin Jonathan Shih, Cambridge, CA (US); Bryan Catanzaro, Los Altos Hills, CA (US)

(21) Appl. No.: 18/483,342

(22) Filed: Oct. 9, 2023

(51) Int. Cl. G10L 13/047; G10L 13/08; G10L 13/10; G10L 17/02; G10L 25/18

(52) U.S. Cl. CPC G10L 13/047; G10L 13/086; G10L 13/10; G10L 17/02; G10L 25/18; G10L 2013/105

(57) ABSTRACT

In various examples, synthesizing speech in multiple languages in conversational AI systems and applications is described herein. Systems and methods are disclosed that use one or more models to synthesize speech from a first language spoken by a speaker to a second, target language selected by the speaker. In some examples, to perform the translation, the model(s) may disentangle one or more attributes associated with speech from speakers, such as speakers' identities, speakers' accents, and text associated with the speech. Additionally, the model(s) may allow for fine-grained control of additional attributes associated with output speech, such as one or more frequencies, one or more energies, and one or more phoneme durations. Furthermore, the model(s) may be configured to use the accent associated with the target language when generating text, such as when aligning text encodings with one or more phonemes.

### BACKGROUND

Recent progress in text-to-speech (TTS) has achieved humanlike speech synthesis quality. Some TTS models support speaker selection during inference by learning a speaker embedding table during training. Other TTS models support zero-shot selection by generating a speaker conditioning vector from a short audio sample. Typical datasets involve a speaker speaking only one language and hence these models generally support only a single language per speaker. Attempts have been made to generate models that are able to use speech from a speaker in an initial language in order to generate additional speech for the speaker in a target language.

For instance, models have been developed that are configured to transfer voice of a speaker from an initial language to a target language. Obtaining datasets with speakers speaking multiple languages is expensive and cumbersome to obtain and hence such models are trained using TTS datasets, where attributes such as speakers' identities, speakers' languages, and speakers' accents are highly correlated. However, training such models using TTS datasets with highly correlated attributes may result in poor language, accent, and speaker transferability. Additionally, such models may use different symbol sets for each language, which may require multiple alphabet sets as well as text encoders. Furthermore, the different symbol sets for each language may severely limit representational sharing across languages, which may further aggravate speaker, language, and text entanglements, especially in TTS datasets with very few speakers per language.

### SUMMARY

Embodiments of the present disclosure relate to synthesizing speech in many languages in conversational AI systems and applications. Systems and methods are disclosed that use one or more models to transfer the voice and/or a timbre associated with a speaker from a first language spoken by a speaker to a second, target language selected by the speaker. In some examples, to preserve the voice and/or the timbre associated with the target language, the model(s) may disentangle one or more attributes associated with speech from speakers, such as speakers' identities, speakers' accents, and text associated with the speech. Additionally, the model(s) may allow for fine-grained control of additional attributes associated with output speech, such as one or more frequencies, one or more energies, and one or more phoneme durations. Furthermore, the model(s) may be configured to use the accent associated with the second language when generating text, such as when producing text encodings corresponding to one or more phonemes.

In contrast to conventional systems, such as those described above that translate text into various languages, the current systems, in some embodiments, disentangle attributes associated with speech, such as speakers' identities, speakers' accents, and text, when training the model(s) and/or using the model(s) for speech translations. As described in more detail herein, disentangling such attributes may improve the language, the accents, and the voice transferability of the model(s) as compared to these conventional models. Additionally, the current systems, in some embodiments, may provide fine-grained control of additional attributes associated with the speech in the target languages, such as frequencies, energies, and phoneme durations. As described in more detail herein, this may also improve the speech that is output in the target languages by the model(s) as compared to the conventional systems. Furthermore, the current systems, in some embodiments, may use a text-to-speech alignment mechanism that both uses a shared phonemic alphabet and uses accents of target languages when performing alignments. As described in more detail herein, this may reduce the symbol sets needed for languages, increase the representation across multiple languages, and generate alignments that the model(s) may use to generate better speech translations.

### BRIEF DESCRIPTION OF THE DRAWINGS

The present systems and methods for synthesizing speech in multiple languages in conversational AI systems and applications are described in detail below with reference to the attached drawing figures, wherein:

FIG. 1 illustrates an example of one or more models that are configured to process text in order to generate speech in a target language, in accordance with some embodiments of the present disclosure;

FIG. 2 illustrates an example of training one or more models to determine attributes associated with a speaker, in accordance with some embodiments of the present disclosure;

FIG. 3 illustrates an example of a pipeline for speech synthesis, in accordance with some embodiments of the present disclosure;

FIG. 4 illustrates a data flow diagram illustrating a process for training one or more models to predict attributes associated with speech, in accordance with some embodiments of the present disclosure;

FIG. 5 illustrates a flow diagram showing a method for translating text into speech in a target language, in accordance with some embodiments of the present disclosure;

FIG. 6 illustrates a flow diagram showing a method for translating text into speech using one or more speech attributes, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

Systems and methods are disclosed related to synthesizing speech in multiple languages in conversational AI systems and applications. For instance, a system(s) may use one or more models to synthesize speech for a speaker that is associated with a target language not spoken by the speaker. In some examples, the model(s) generates the speech with a native accent associated with the target language while still retaining one or more characteristics associated with a speaker's voice and/or timbre, where the speaker provided the text for translation. For example, if a speaker provides additional speech in an initial language, the model(s) may learn the characteristic(s) of the speaker's voice while also removing one or more attributes associated with the speech, such as an accent associated with the speech. The model(s) may then use the learned characteristic(s), with the accent, to synthesize speech in the target language selected by the speaker while retaining the characteristics of the voice. In order to make the target speech more realistic, the model(s) may use at least an accent learned from speech provided by other speakers when speaking in the target language. Additionally, the model(s) may use one or more additional attributes learned during training, such as one or more frequencies, one or more energies, and/or one or more phoneme durations associated with the speech.

For more details, the system(s) may receive text representing one or more words, one or more symbols, one or more numbers, and/or the like. In some examples, the system(s) receives the target text, the relevant speaker and the target language as input, where the speaker may or may not have spoken the target language in the training datasets. The system(s) (e.g., the model(s)) may then use an alphabet that is shared across multiple languages, such as the International Phonetic Alphabet (IPA), to represent the text using tokens. By representing the text using such a shared alphabet, the system(s) is able to generate a phoneme-based shared textual representation of the text in the target language associated with the speech. The system(s) may then use one or more techniques to align the text with speech. In some examples, the system(s) performs the alignment using one or more text-to-speech (TTS) models and/or one or more external forced aligners. In other examples, the system(s) may have components that learn these text-to-speech (TTS) alignments as the model trains. In some examples, the system(s) uses additional techniques to perform the alignment, such as by modifying the TTS model(s), alignment learning component and/or the external forced aligner(s) using an accent associated with the target language that is learned during training.

The system(s) may then use speaker data associated with the speaker, text data associated with the aligned text in the target language, and accent data associated with the target language to generate the speech in the target language. For instance, and as described herein, the speaker data may represent at least an identifier associated with the speaker, one or more characteristics associated with a voice of the speaker, one or more languages that are spoken by the speaker, and/or any other information associated with the speaker. In some examples, and as described herein, the system(s) learns the characteristic(s) associated with the voice of the speaker during training using audio data representing one or more instances of speech from the speaker. Additionally, in some examples, to improve the performance of the translation, the system(s) may use one or more techniques to disentangle one or more attributes associated with the speech from the speaker. For example, the system(s) may at least disentangle accent associated with the speech from the text of the speech and/or the identity of the speaker.

The accent data associated with the target language may represent one or more accents associated with the target language, which the model(s) may use when generating the speech associated with the text in the target language. In some examples, and as described in more detail herein, the system(s) may learn the accent(s) associated with the target language during training, such as by processing audio data representing one or more instances of speech that are spoken in the target language. Additionally, in some examples, by using the accent(s) associated with the target language instead of the accent associated with the speaker for which the translation is being performed, the system(s) may generate the speech that more closely relates to actual speech that is spoken in the target language by a native speaker of the language.

In some examples, the system(s) may then use the speaker data, the text data, and/or the accent data to determine one or more additional attributes for generating the speech in the target language. For example, the model(s) may process the speaker data, the text data, and/or the accent data to predict one or more phoneme durations associated with the text. Additionally, the model(s) may process the phoneme duration(s), the speaker data, the text data, and/or the accent data to determine one or more frequencies associated with the speech, one or more energies associated with the speech, and/or any other attributes associated with the speech. In some examples, the one or more frequencies and/or the one or more energies associated with the speech are related to one or more frames of the speech. The system(s) may then use the speaker data, the text data, the accent data, the phoneme duration(s), the one or more frequencies, and/or the one or more energies to generate the speech associated with the text, where the speech is in the target language.

For example, the model(s) (e.g., a decoder of the model(s)) may process the speaker data, the text data, the accent data, the phoneme duration(s), the one or more frequencies, and/or the one or more energies. Based at least on the processing, the model(s) may generate one or more spectrograms, such as one or more synthesized mel-spectrograms, associated with the speech. A separate model(s) (e.g., a vocoder(s)) may then process the spectrogram(s) and, based at least on the processing, generate audio data representing audio associated with the speech. As described herein, in some examples, even though the model(s) uses the characteristic(s) associated with the voice of the speaker, the audio may include the accent(s) associated with the target language instead of the accent associated with the speaker. This way, the speech associated with the audio may better represent actual speech associated with one or more speakers that speak the target language.

In some examples, the system(s) may perform one or more processes to determine at least some of the data that is used by the model(s) to generate the speech. For example, such as to learn information (e.g., the attributes) associated with the speaker, the system(s) may receive audio data representing one or more instances of speech from the speaker in at least one initial language. The system(s) may then process the audio data using the model(s) to determine at least the characteristic(s) associated with the voice of the user, where the characteristic(s) is then used by the model(s) when generating the speech in the target language. Additionally, such as to learn the information (e.g., the attributes) associated with the target language, the system(s) may receive audio data representing one or more instances of speech from one or more other speakers that speak the target language. The system(s) may then process the audio data using the model(s) in order to determine at least the accent(s) associated with the target language, where the accent(s) is then used by the model(s) when generating the speech in the target language. In some examples, the model(s) may process the audio data to determine additional attributes associated with the voice of the speaker and/or the target language, such as a volume, a pace, a pitch, a resonance, and/or the like. In such examples, the additional attributes may further be used by the model(s) when generating the speech.

As described herein, the model(s) may be trained to synthesize speech corresponding to desired selected speaker in various languages. For example, the model(s) may be trained to synthesize speech in English, French, Chinese, German, Portuguese, Spanish, Swedish, Hindi, and/or any other language.

The systems and methods described herein may be used for a variety of purposes, by way of example and without limitation, for machine control, machine locomotion, machine driving, synthetic data generation, model training, perception, augmented reality, virtual reality, mixed reality, robotics, voice conferencing, gaming, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, text translations, speech translations, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems that perform voice conferencing, systems that implement gaming applications, systems that implement one or more large language models (LLMs), systems for performing light transport simulation, systems for performing collaborative content creation for 3D assets, systems implemented at least partially using cloud computing resources, and/or other types of systems.

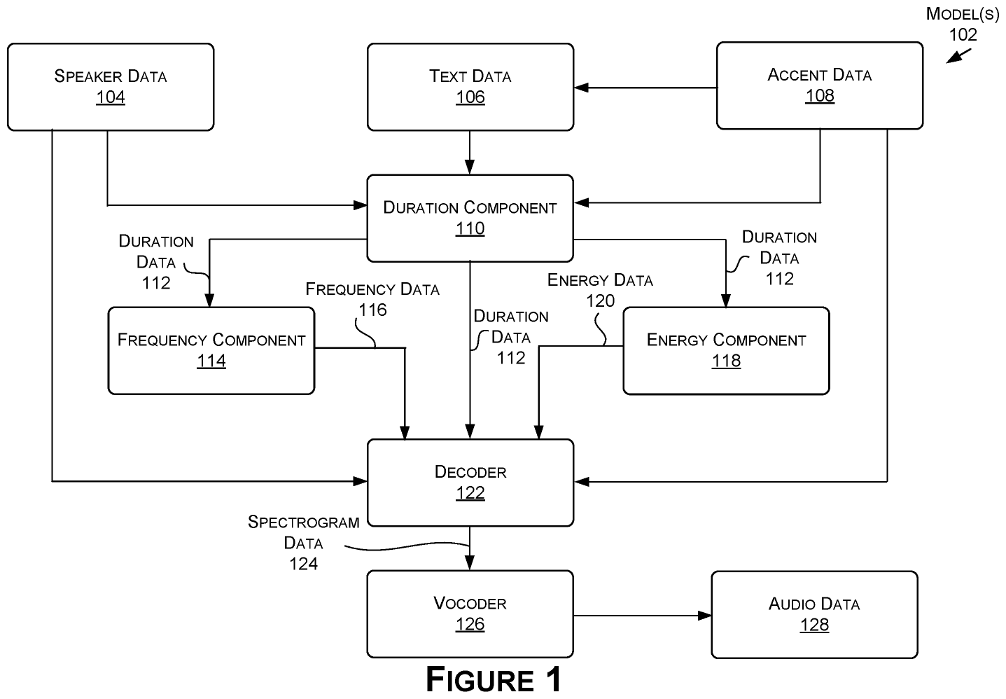

With reference to FIG. 1, FIG. 1 illustrates an example of one or more models 102 that are configured to process text in order to generate speech in a target language, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown, the model(s) 102 may use various types of variables when processing text in order to generate speech in a target language. For instance, the model(s) 102 may use speaker data 104 representing information associated with a speaker for which the speech is being generated. As described herein, the speaker data 104 may represent at least an identifier associated with the speaker, one or more characteristics associated with a voice of the speaker, one or more languages that are spoken by the speaker (and/or for which the model(s) 102 has been trained), and/or any other information associated with the speaker. As described herein, an identifier associated with the speaker may include, but is not limited to, a name of the speaker, a username associated with the speaker, an alphabetic identifier associated with the speaker, a numerical identifier associated with the speaker, an alphanumerical identifier associated with the speaker, and/or any other type of identifier that may be used to identify the speaker. The characteristic(s) associated with the voice of the speaker may include, but is not limited to, a timbre, a volume, a pace, a pitch, a resonance, and/or any other attributes that may be associated with the voice. However, in some examples and as described herein, the characteristic(s) may not include one or more additional characteristics, such as an accent associated with the voice.

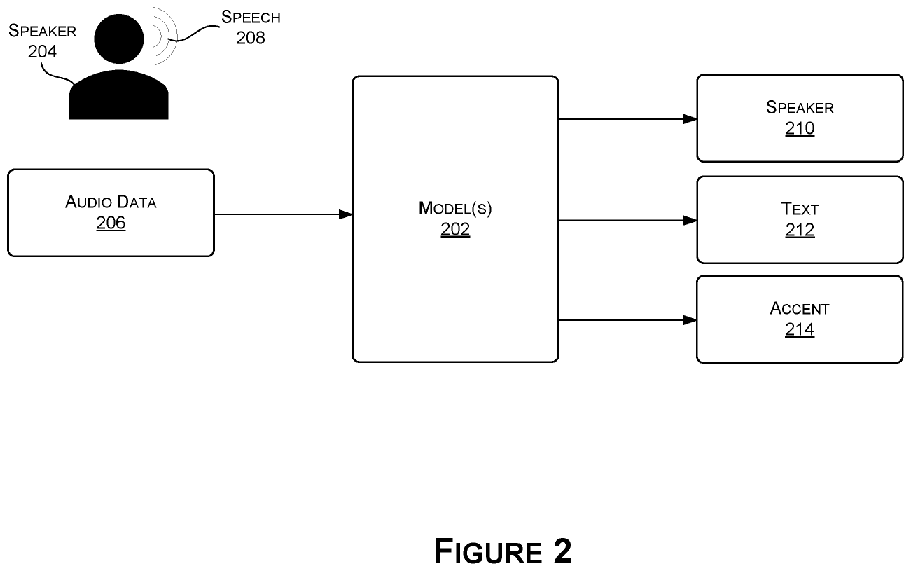

For example, FIG. 2 illustrates an example of training one or more models 202 (which may represent, and/or include, the model(s) 102) to determine attributes associated with a speaker 204, in accordance with some embodiments of the present disclosure. As shown, the model(s) 202 may process audio data 206 associated with the speaker 204. For instance, and as described herein, the audio data 206 may represent one or more instances of speech 208 spoken by the speaker 204, wherein the instance(s) of speech 208 is spoken in one or more languages by the speaker 204. For a first example, the audio data 206 may represent a single instance of speech 2-8 that is output by the speaker 204 for a specific duration. As described herein, a duration may include, but is not limited to, one second, one minute, five minutes, ten minutes, thirty minutes, forty-five minutes, one hour, and/or any other duration. For a second example, the audio data 206 may represent multiple instances of speech 208 that our output by the speaker 204 for one or more durations.

The model(s) 202 may process the audio data 206 and, based at least on the processing, disentangle one or more attributes associated with the speech 208. As shown, the attributes may include at least a speaker 210 (e.g., the identity of the speaker 204, the voice of the speaker 204, etc.), text 212 to be synthesized 208, and an accent 214 associated with the speaker 204. As will be described in more detail herein, by performing such disentanglement, the model(s) 202 may be able to later (1) preserve the identity of the speaker 204 in the target language when generating additional speech and/or (2) remove the speaker's accent 214 in the spoken language from the additional speech in the target language.

For instance, and for more details, the system(s) may focus on non-parallel data with a speaker speaking one or more languages (e.g., a single language), which typically includes text, accent A, and speaker S entangled. The system(s) may then use one or more techniques to disentangle these attributes. For example, such as in TTS datasets, speakers typically read different text and have different prosody. Hence, there may be entanglement between the speaker S, the text ¢, and the prosody. As such, the model(s) 202 may employ domain adversarial training to disentangle the speaker S and the text ¢ by using one or more gradient reversal layers. The system(s) may then use a speaker classification loss, and backpropagate a classifier's negative gradients through a text encoder and token embeddings using the following:

$${L}_{a d v} = {\sum }_{i = 1}^{N} P ( {s}_{i} \vert {ϕ}_{i} ; {θ}_{spkclassifier} ) \qquad ( 1 )$$

In some examples, disentangling an accent A and a speaker S is challenging since the speaker S typically has a specific way of pronouncing words, which may cause a strong association between the speaker S and the accent A. Since the goal of the model(s) 202 may be to synthesize speech for the speaker S in a target language with a desired accent, disentangling the speaker S and the accent A may be essential. As such, to perform the disentanglement, the model(s) 202 may use data augmentations such as formant F₀ and duration scaling. For example, and for a given speech sample xᵢ with speaker identity sᵢ and accent aᵢ, the model(s) 202 may apply a fixed transformation t∈{1, 2, . . . τ} to construct a transformed speech sample xᵢ^{t} and assign speaker identity as sᵢ+t·Nₛₚₑₐₖₑᵣₛ and accent as original accent aᵢ, where τ is the number of augmentations. In some examples, performing such processes may create speech samples with variations in speaker identity and fixed accent, which may increase the quality of synthesized speech by better disentangling these attributes.

As described herein, the information captured by the speaker and the accent embeddings should be uncorrelated. As such, to promote disentanglement between accent and speaker embeddings, the system(s) may aim to decorrelate the following variables: (1) random variables in accent embeddings; (2) random variables in speaker embeddings; and (3) random variables in speaker and accent embeddings from each other. In some examples, to perform the decorrelating, constraints may include accent embedding tables E^{A}∈ [symbol] and speaker embedding tables E^{S}∈ [symbol] . Column vector e^{j}∈E may then denote the j′th embedding in either the accent embedding table and/or the speaker embedding table. In some examples, the standard deviations may then be constrained by at least γ and off-diagonal elements may be suppressed of the covariance matrix (γ=1, ϵ=1e−4), with the following equations then applying:

$${L}_{var} = \frac{1}{D} {\sum }_{i = j} max ( 0 , γ - \sqrt{Cov {( E )}_{i , j} + ϵ} \qquad ( 2 )$$

$${L}_{covar} = {\sum }_{i \neq j} Cov {( E )}_{i , j}^{2} \qquad ( 3 )$$

In some examples, the model(s) 202 attempts to decorrelate accent and speaker variables from each other by minimizing the cross-correlation matrix from batch statistics. For instance, let \tilde{E}^{A} and \tilde{E}^{S} respectively be the sampled column matrices of accent and speaker embedding vectors sampled within a batch of size B. The system(s) may compute the batch cross-correlation matrix R^{AS} as follows (with μ_{E}_{^{A}} and μ_{E}_{^{S}} computed from embedding table):

$${R}^{A S} = \frac{1}{B - 1} ( {\tilde{E}}^{{}_{A}} - {μ}_{{E}^{A}} ) {( {\tilde{E}}^{{}_{S}} - {μ}_{E} s )}^{T} \qquad ( 4 )$$

$${L}_{xcorr} = \frac{1}{{D}_{a} {D}_{s}} {\sum }_{i , j} {( {R}_{i , j}^{A S} )}^{2} \qquad ( 5 )$$

While these are just a few example equations for disentangling the attributes associated with speech, in other examples, the system(s) and/or the model(s) 202 may perform additional and/or alternative techniques to disentangle the attributes.

Referring back to the example of FIG. 1, the model(s) 102 may use text data 106 (e.g., another variable) associated with text for which the speaker wants translated into the target language. In some examples, the text data 106 may be generated using input data received from one or more user devices, where the input data represents the text. For example, the speaker may input the text for which the speaker wants translated. In some examples, the text data 106 may be generated using audio data representing user speech from the speaker, where the user speech is associated with a language other than the target language. For instance, the system(s) may process the user speech in order to determine the text for which the speaker wants translated into the target language. As described herein, the text may include one or more words, one or more symbols, one or more numbers, and/or the like.

In some examples, text tokens associated with the text may be represented using one or more alphabets that are shared across multiple languages, such as the International Phonetic Alphabet (IPA), to enforce a phoneme-based shared textual representation. In such examples, a shared alphabet across languages reduces the dependence of text on speaker identity, such as in low-resource settings (e.g., one speaker per language) and supports code-switching. In some examples, an online alignment learning algorithm is used to learn speech-text alignments Λ= [symbol] without external dependencies. In some examples, the shared alphabet set simplifies the alignment since alignments are learned on a single token set instead of distinct sets. In some examples, since the same token may be spoken in different ways due to differences in a speaker's accent, the model(s) 102 may learn alignments between text and accent A and/or a spectrogram may use accent A as a conditioning variable. In other words, the model(s) 102 may use the accent A of the target language to better perform the alignment.

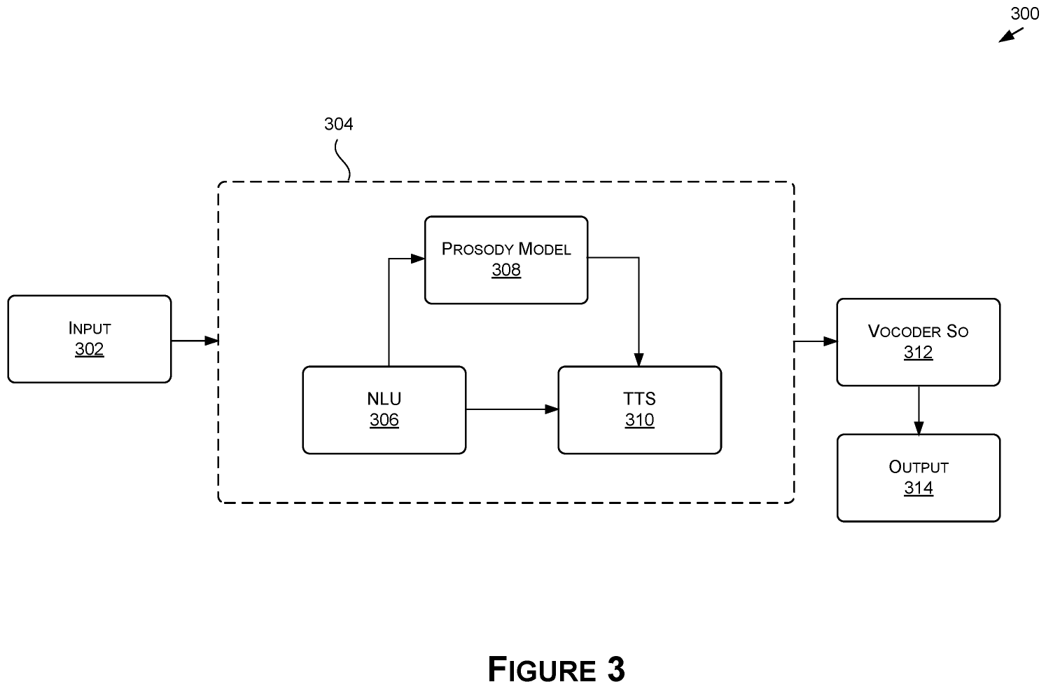

For more details, FIG. 3 illustrates an example of a pipeline for speech synthesis, in accordance with some embodiments of the present disclosure. A text-to-speech (TTS) pipeline 300, which may also be referred to as speech synthesis, includes an input 302 that may correspond to a textual input and/or an accent associated with a target language. It should be appreciated that the input may be an initial text input, such as an input provided by a speaker, a converted text input, such as an utterance that has been evaluated and then converted to text, a sequence of text extracted from an input image or video, and/or the like. In some examples, the input 302 may be responsive to a question or comment provided by a speaker, such as a conversational artificial intelligence (AI) system that provides answers responsive to user queries, among other applications. The illustrated input 302 may be formatted for inclusion within a processing framework 304, that may include one or more trained machine learning systems to evaluate the input 302 for one or more features, which may enable conversion of the input 302 into an audio output that emulates human speech.

In some examples, the processing framework 304 includes a natural language understanding (NLU) system 306, a prosody model 308, and a TTS module 310. As will be appreciated, the NLU system 306 may be utilized with one or more conversational AI systems to enable humans to interact naturally with devices. The NLU system 306 may be utilized to interpret context and intent of the input 302 in order to generate a response. For example, the input 302 may be preprocessed, which may include tokenization, lemmatization, stemming, and other processes. Additionally, in some examples, the NLU system 306 may include one or more deep learning models, such as a BERT model, to enable features such as entity recognition, intent recognition, sentiment analysis, and others. Furthermore, the NLU system 306 may enable conversion of linguistic units of the input 302 into phonemes, which may then be assembled together using the prosody model 308.

The TTS model 310 may take a text response generated by the NLU system 306 and change it to natural-sounding speech. It should be appreciated that, in some examples, the prosody model 308 may be part of the TTS model 310. The output from the NLU system 306 may undergo various processes associated with the TTS model 310, such as linguistic analysis, synthesis, and/or the like. Additionally, parts of speech may be tagged. In some examples, the output may be further analyzed for refining pronunciations, calculating the duration of words, deciphering the prosodic structure of utterance, and understanding grammatical information. Additionally, text may be converted to spectrograms, such as mel-spectrograms, for output to a vocoder 312 to generate waveforms. As noted above, it should be appreciated that, in some examples, the vocoder 312 may be incorporated into the TTS model 310. Accordingly, an audio output 314 is generated that sounds like human speech.

For more details, the alignment framework may take an encoded text input Φ∈ [symbol] and align it to mel-spectrograms X∈ [symbol] , where T is the number of mel frames and N is the text length. To learn the alignment between mel-spectrograms (X) and text (Φ), an alignment learning objective may be used. The objective may be to maximize the likelihood of text given mel-spectrograms using a forward-sum algorithm, such as one used in Hidden Markov Models. In some examples, the alignment between text and speech may be constrained to be monotonic in order to avoid missing or repeating tokens. As such, the following equation may summarize the conditional likelihood of text:

$$P ( S ( Φ ) \vert X ; θ ) = {\sum }_{s ∈ S ( Φ )} {\prod }_{t = 1}^{T} P ( {s}_{t} \vert {x}_{t} ; θ ) \qquad ( 6 )$$

In equation (6), s is a specific alignment between mels and text, S(Φ) is the set of all possible valid monotonic alignments, and (sₜ|xₜ) is the likelihood of a specific text token sₜ=ϕᵢ aligned for mel frame xₜ at timestep t.

If using an autoregressive TTS, an encoder may be used to obtain a sequence of encoded text representations (ϕᵢ^{enc})ᵢ₌₁^{N} and attention RNN to produce a sequence of hidden states ht. A simple architecture is then used to compute the alignment energies e_{t,i} for text token sᵢ at timestep t for mel xₜ using the tan h attention. The attention weights are then computed with softmax over the text domain using the alignment energies. The following equations summarize the attention mechanism:

$${( {h}_{t} )}_{t = 1}^{T} = RNN ( {h}_{t - 1} , {x}_{t - 1} , {c}_{t - 1} ) \qquad ( 7 )$$

$${c}_{t} = \sum {α}_{t} , i {ϕ}_{i}^{e n d} \qquad ( 8 )$$

$${f}_{t} = F ( {α}_{t - 1} ) \qquad ( 9 )$$

$${e}_{t , i} = - {v}^{T} tanh ( W {h}_{t} + V {ϕ}_{i}^{e n c} + U {f}_{t , i} ) \qquad ( 10 )$$

$$P ( {s}_{t} = {ϕ}_{i} \vert {x}_{i} ) = {α}_{t , i} = {Softmax ( - {e}_{t} )}_{i} \qquad ( 11 )$$

In equations (7)-(11), fₜ is the location relative term for location sensitive attention F. The attention weights model the distribution P (sₜ=ϕᵢ|xᵢ), which is then incorporated as the alignment loss:

$${ℒ}_{align} = {ℒ}_{ForwardSum} \qquad ( 12 )$$

In some examples, parallel TTS models may have durations factored out from the decoder and the alignment learning module may be decoupled from the mel decoder as a standalone aligner. This may provide flexibility in choosing the architecture to formulate P(sₜ|xₜ), where sₜ is a random variable for a text token alignment at timestep t for mel frame xₜ. Similarly, the soft alignment distribution based on the learned pairwise affinity between all text tokens and mel frames, which is normalized with softmax across the text domain, may be determine by the following:

$${D}_{i , j} = d i s {t}_{L 2} ( {ϕ}_{i}^{e n c} , {x}_{j}^{e n c} ) \qquad ( 13 )$$

$${soft}_{} = softmax ( - D , d i m = 0 ) \qquad ( 14 )$$

In some examples, two simple convolutional encoders are used for encoding text Φ and Φ^{enc} and mel-spectrograms X as X^{enc} with 2 and 3 1D convolutional layers, respectively. Following this, a Viterbi algorithm may be used to find the most likely monotonic path through the soft alignment map in order to convert soft alignments ( [symbol] _{soft}) to hard alignments ( [symbol] _{hard}). In some examples, the gap between the soft and hard alignments may be closed by forcing ( [symbol] _{soft}) to match ( [symbol] _{hard}) as much as possible by minimizing their KL-divergence ( [symbol] _{bin}):

$${ℒ}_{b i n} = {hard}_{} ⊙ log {soft}_{} \qquad ( 15 )$$

$${ℒ}_{align} = {ℒ}_{ForwardSum} + {ℒ}_{bin} \qquad ( 16 )$$

In equation (15), ⊙ is a Hadamard product and [symbol] _{align} is a final alignment loss.

In some examples, faster convergence of alignments means faster training of the TTS model, as training the decoder needs a stable alignment. In some examples, the length of mel-spectrograms is known upfront during training and, as such, a static 2D prior may be used, where the 2D prior is wider near the center and narrower near the corners to accelerate the alignment by making far-off-diagonal elements less probable. For instance, a prior (f_{B}) may be applied over the alignment (P(s|X=xₜ)) to obtain the following posterior:

$${f}_{B} ( k , α , β ) = ( \begin{matrix}N \\ k\end{matrix} ) \frac{B ( k + α ) B ( N - k + β )}{B ( α , β )} \qquad ( 17 )$$

$${P}_{posterior} ( Φ = {ϕ}_{k} \vert X = {x}_{t} ) = P ( Φ = {ϕ}_{k} \vert X = {x}_{t} ) ⊙ {f}_{b} ( k , ω t , ω ( T - t + 1 ) ) \qquad ( 18 )$$

In equations (17) and (18), for k={0, . . . , N}, α, β are hyperparameters of beta function B(⋅, ⋅), N is the number of tokens, and w is a scaling factor controlling width of prior.

Referring to the example of FIG. 1, the model(s) 102 may use accent data 108 (e.g., a third variable) representing one or more accents associated with the target language for which the speech is being generated. As described herein, the accent(s) represented by the accent data 108 may be learned during training, such as by audio data representing instances of speech spoken in the target language. For instance, in some examples, the accent(s) represented by the accent data 108 may be learned using similar techniques as those described with respect to FIG. 2 to disentangle the accent 214 from the speech 208. For example, the accent(s) represented by the accent data 108 may be learned using one or more of the equations described herein with respect to FIG. 2.

For example, and as described herein, the model(s) 102 may be trained to translate text into one or more languages. As such, if the model(s) 102 is then later trained for a new language, the model(s) 102 may receive audio data (e.g., the audio data 206) representing one or more instances of speech from one or more speakers, where the instance(s) of speech are in the new language. The model(s) 102 may then process the audio data using the techniques described with respect to FIG. 2 and/or one or more of the equations described with respect to the description of FIG. 2 in order to learn one or more attributes associated with speech in the new language. As described herein, an attribute associated with speech may include, but is not limited to, an accent, a volume, a pace, a pitch, a resonance, and/or the like. As such, based at least on processing the audio data, the model(s) 102 may learn at least one or more accents associated with the associated language. Accent is defined as how the sequence of phonemes would be pronounced by a native speaker of the target language. The model(s) 102 may then later use the learned accent(s) when synthesizing speaker's voice in the new language (e.g., the accent data 108 may represent the accent(s)).

As described herein, the model(s) 102 may be configured to perform fine-grained control of speech attributes (also referred to as “features”) using the speaker data 104, the text data 106, and/or the accent data 108. For instance, and as shown by the example of FIG. 1, a duration component 110, which may include one or more layers and/or other components of the model(s) 102, may predict phoneme durations associated with the speech using the speaker data 104, the text data 106, and/or the accent data 108. For example, since a phoneme may represent a discrete unit corresponding to a sound of speech, the phoneme duration may represent the duration associated with the discrete unit of the sound of the speech. In some examples, since different accents may cause different durations associated with speech, the phoneme durations may depend on the accent(s) represented by the accent data 108. The output from the duration component 110 may then include duration data 112 representing an expanded text representation associated with the text and/or the phoneme durations associated with the expanded text representation.

A frequency component 114, which may include one or more layers and/or other components of the model(s) 102, may predict frequencies associated with the speech using the duration data 112 (and/or, in some examples, the speaker data 104, the text data 106, and/or the accent data 108). As described herein, in some examples, a frequency may include fundamental frequency, which refers to the frequency at which vocal folds vibrate when voice speech sounds are made. In some examples, the frequency component 114 may predict the frequencies for one or more frames (e.g., each frame) associated with the speech. The output from the frequency component 114 may then include frequency data 116 representing the frequencies associated with the speech.

An energy component 118, which may include one or more layers and/or other components of the model(s) 102, may predict energies associated with the speech using the duration data 112 (and/or, in some examples, the speaker data 104, the text data 106, and/or the accent data 108). As described herein, in some examples, an energy may correspond to an amplitude (e.g., an average amplitude) of a spectrogram (e.g., a mel-spectrogram) corresponding to a speech signal. In some examples, the energy component 118 may predict the energies for one or more frames (e.g., each frame) associated with the speech. In some examples, an energy may represent an amplitude associated with a mel-spectrogram. The output from the energy component 118 may then include energy data 120 representing the energies associated with the speech.

As further illustrated in the example of FIG. 1, the model(s) 102 may include a decoder 122 that uses, as input, the speaker data 104, the accent data 108, the duration data 112, the frequency data 116, and/or the energy data 120 (and/or, in some examples, the text data 106). Based at least on processing the inputted data, the decoder 122 may be configured to output spectrogram data 124 representing one or more spectrograms, such as one or more synthesized mel-spectrograms, associated with the speech.

As described in more detail, an extra conditioning variable for accent A may be introduced to allow for accent controllable speech synthesis. As such, the model(s) 102 may be described by the following equation:

$${P}_{radtts} ( X , Λ ) = {P}_{m e l} ( X \vert Φ , Λ , A , S ) {P}_{dur} ( Λ \vert Φ , A , S ) \qquad ( 19 )$$

In some examples, the fine-grained control of speech attributes like the frequencies F₀ and the energies & may provide for high-quality speech synthesis. For instance, conditioning such attributes may help improve accent and language transfer. During training, the decoder 122 may be conditioned on ground truth frame-level frequencies F₀ and energies ε. In some examples, deterministic attribute predictors may also be trained to predict the phoneme durations Λ, the frequencies F₀, and the energies ε conditioned on speaker S, encoded text Φ, and accent A. In some examples, the frequencies F₀ may be standardized using the speaker's frequencies F₀ mean and standard deviation to remove speaker-dependent information. This may allow the model(s) 102 to predict speech attributes for any speaker, accent, and language and control the mel synthesis with such features. For instance, the model(s) 102 may then be described by one or more of the following equations:

$${P}_{radmmm} ( X ) = {P}_{m e l} ( X \vert Φ , {Λ}^{h} , A , S , {F}_{0}^{h} , {ε}^{h} ) \qquad ( 20 )$$

$${P}_{radmmm} ( X , Λ ) = {P}_{m e l} ( X \vert Φ , Λ , A , S , {F}_{0} , ε ) {P}_{{F}_{0}} ( {F}_{0} \vert Φ , A , S ) {P}_{ε} ( ε \vert Φ , A , S ) {P}_{dur} ( Λ \vert Φ , A , S ) \qquad ( 21 )$$

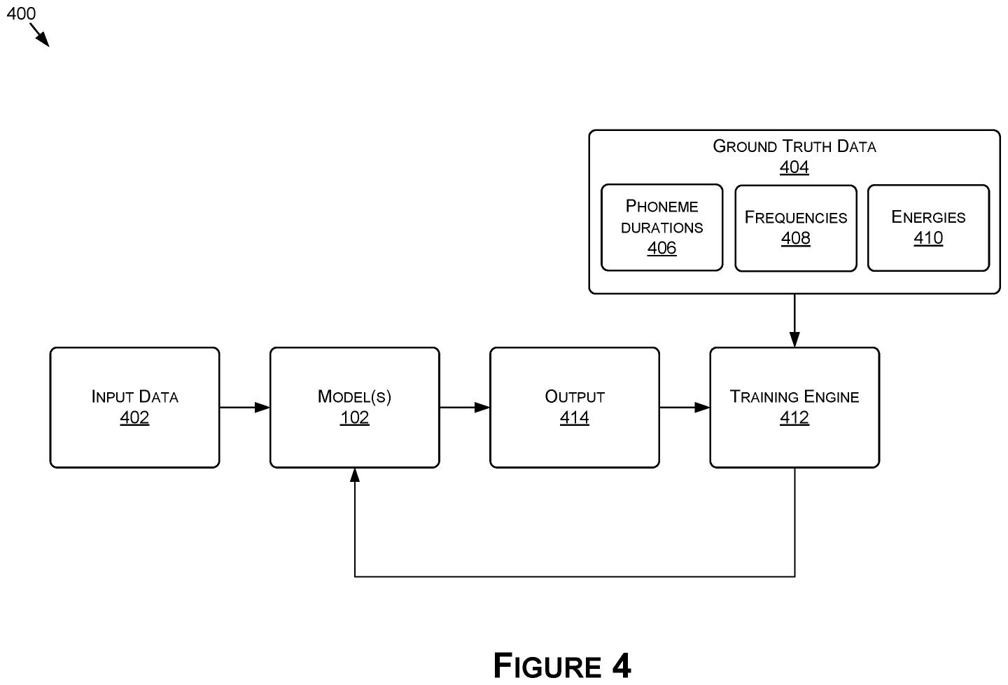

For instance, FIG. 4 is a data flow diagram illustrating a process for training the model(s) 102 to predict attributes associated with speech, in accordance with some embodiments of the present disclosure. For example, the model(s) 102 may be trained such that the duration component 110, the frequency component 114, and the energy component 118 are able to predict the phoneme durations Λ, the frequencies F₀, and/or the energies ε associated with speech, respectively. As described herein, the model(s) 102 may predict one or more of the attributes based at least on the speaker S, the text @, and the accent A. For instance, and as shown, the model(s) 102 may be trained using input data 402. In some examples, the input data 402 may represent the speakers S, the text Φ, and the accents A. However, in other examples, the input data 402 may include audio data representing one or more instances of speech.

The model(s) 102 may be trained using the training input data 402 as well as corresponding ground truth data 404. The ground truth data 404 may include annotations, labels, masks, and/or the like. For instance, in some examples, the ground truth data 404 may include at least phoneme durations Λ 406, the frequencies F₀ 408, and/or the energies ε 410. The ground truth data 404 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the input data 402, there may be corresponding ground truth data 404.

A training engine 412 may use one or more loss functions that measure loss (e.g., error) in outputs 414 (which may represent phoneme durations, frequencies, and/or energies) as compared to the ground truth data 404. Any type of loss function may be used, such as cross entropy loss, mean squared error, mean absolute error, mean bias error, and/or other loss function types. In some examples, different outputs 414 may have different loss functions. For example, the phoneme durations may have a first loss function, the frequencies may have a second loss function, and/or the energies may have a third loss function. In such examples, the loss functions may be combined to form a total loss, and the total loss may be used to train (e.g., update the parameters of) the model(s) 102. In any example, backward pass computations may be performed to recursively compute gradients of the loss function(s) with respect to training parameters. In some examples, weights and biases of the model(s) 102 may be used to compute these gradients.

Referring back to the example of FIG. 1, the model(s) 102 may include a vocoder 126 that is configured to process the spectrogram data 124 output by the decoder 122. Based at least on the processing, the vocoder 126 may generate and/or output audio data 128 representing audio associated with the speech in the target language. As described herein, by using the accent data 108 associated with the target language, and also disentangling the accent associated with the speaker, the speech represented by the audio data 128 may include the accent(s) associated with the target language rather than the accent associated with the speaker. This way, and in some examples, the speech may better represent actual speech from one or more speakers that speak the target language. Additionally, the speech represented by the audio data 128 may still include one or more characteristics associated with the voice of the speaker, such that the speech sounds like it is coming from the speaker.

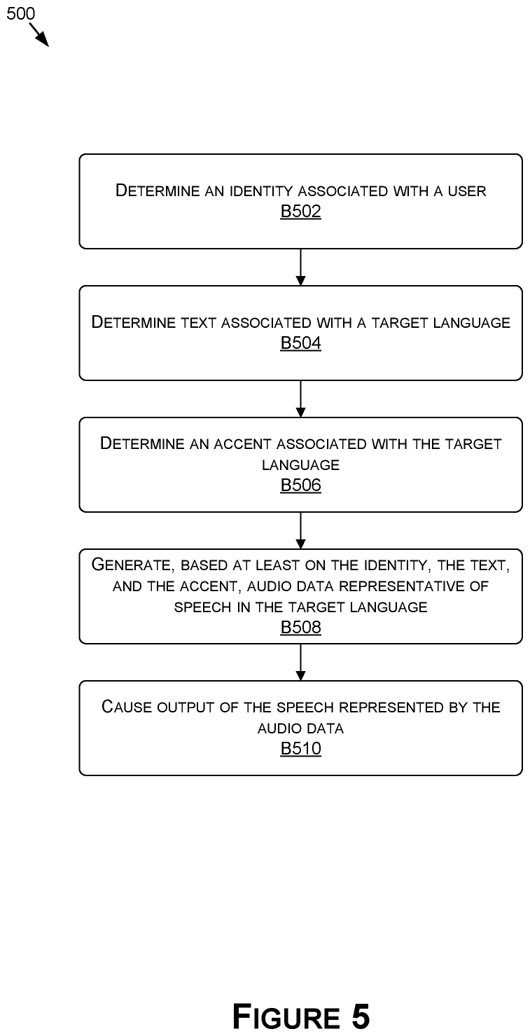

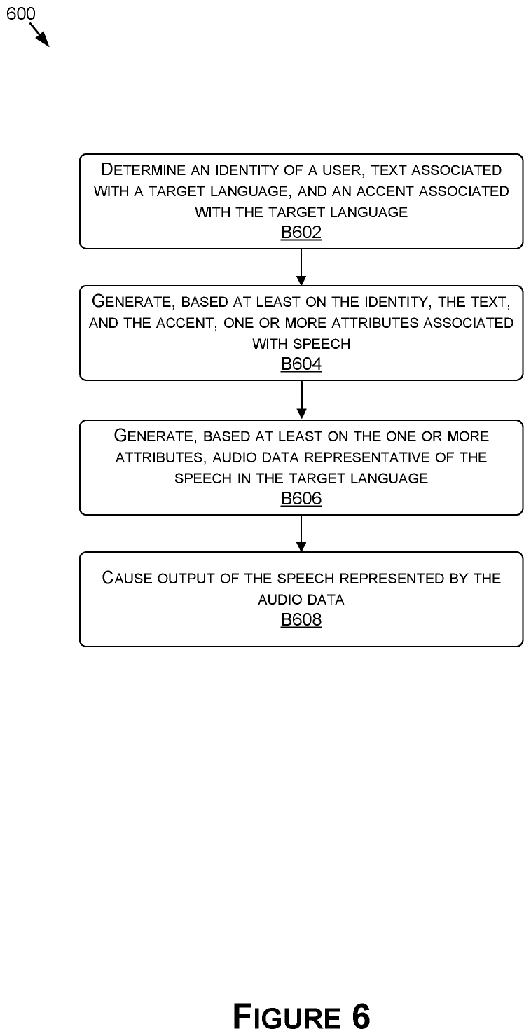

Now referring to FIGS. 5 and 6, each block of methods 500 and 600, described herein, comprises a computing process that may be performed using any combination of hardware, firmware, and/or software. For instance, various functions may be carried out by a processor executing instructions stored in memory. The method 500 and 600 may also be embodied as computer-usable instructions stored on computer storage media. The methods 500 and 600 may be provided by a standalone application, a service or hosted service (standalone or in combination with another hosted service), or a plug-in to another product, to name a few. In addition, the method 500 and 600 are described, by way of example, with respect to FIG. 1. However, the methods 500 and 600 may additionally or alternatively be executed by any one system, or any combination of systems, including, but not limited to, those described herein.

FIG. 5 illustrates a flow diagram showing a method 500 for synthesizing speech in a target language, in accordance with some embodiments of the present disclosure. The method 500, at block B502, may include determining an identity associated with a user. For instance, a system(s) may determine, generate, obtain, and/or receive the speaker data 104 associated with the user. As described herein, the speaker data 104 may represent at least an identifier associated with the user, one or more characteristics associated with a voice of the user, one or more languages that the user speaks, and/or any other information associated with the user. In some examples, the characteristics associated with the voice may not include an accent associated with the user speaking in an initial language that differs from the target language.

The method 500, at block B504, may include determining text associated with a target language. For instance, the system(s) may determine, generate, obtain, and/or receive the text data 106 associated with the text. As described herein, in some examples, the text data 106 may be generated using audio data representing user speech from the user, where the user speech is associated with a language other than the target language. In some examples, the text data 106 may be generated using input data received from one or more user devices, where the input data represents the text. In some examples, text encodings associated with the text may be aligned with phonemes. Still, in some examples, the alignment is performed using one or more accents associated with the target language.

The method 500, at block B506, may include determining an accent associated with the target language. For instance, the system(s) may determine, generate, obtain, and/or receive the accent data 108 associated with the target language. As described herein, the accent(s) represented by the accent data 108 may be learned during training, such as by using audio data representing instances of speech spoken in the target language by one or more other users.

The method 500, at block B508, may include generating, based at least on the identity, the text, and the accent, audio data representative of speech in the target language. For instance, the model(s) 102 may initially process the speaker data 104, the text data 106, and/or the accent data 108 to determine attributes associated with the speech. As described herein, the attributes may include at least phoneme durations, frequencies, and/or energies associated with the speech. The model(s) 102 (e.g., the decoder 122) may then process the speaker data 104, the accent data 108, the duration data 112 representing the phoneme durations, the frequency data 116 representing the frequencies, and/or the energy data 120 representing the energies in order to generate the spectrograms. Additionally, the model(s) 102 (e.g., the vocoder 126) may process the spectrogram data 124 representing the spectrograms in order to generate the audio data 128 representing the speech in the target language.

The method 500, at block B510, may include causing output of the speech represented by the audio data. For instance, the system(s) may cause, such as by using one or more output devices and/or components, the output of the speech as represented by the audio data 128.

FIG. 6 illustrates a flow diagram showing a method 600 for translating text into speech using one or more speech attributes, in accordance with some embodiments of the present disclosure. The method 600, at block B602, may include determining an identity associated with a user, text associated with a target language, and an accent associated with the target language. For instance, a system(s) may determine, generate, obtain, and/or receive the speaker data 104 associated with the user, the text data 106 associated with the text, and the accent data 108 associated with the accent. As described herein, the text data 106 may be generated using the accent data 108 such that the text is associated with the target language.

The method 600, at block B604, may include generating, based at least on the identity, the text, and the accent, one or more attributes associated with speech. For instance, the model(s) 102 may process the speaker data 104, the text data 106, and/or the accent data 108 using the duration component 110. Based at least on the processing, the model(s) 102 may generate the duration data 112 representing phone durations. The model(s) 102 may also process the duration data 112, the speaker data 104, the text data 106, and/or the accent data using the frequency component 114 and/or the energy component 118. Based at least on the processing, the model(s) 102 may generate the frequency data 116 representing the frequencies and/or the energy data 120 representing the energies.

The method 600, at block B606, may include generating, based at least on the one or more attributes, audio data representative of the speech in the target language. For instance, the model(s) 102 (e.g., the decoder 122) may process the duration data 112, frequency data 116, and/or the energy data 120 (and/or, in some examples, the speaker data 104, the text data 106, and/or the accent data 108). Based at least on the processing, the model(s) 102 may generate spectrograms associated with the speech. The model(s) 102 (e.g., the vocoder 126) may then process the spectrogram data 124 representing the spectrograms in order to generate the audio data 128 representing the speech in the target language.

The method 600, at block B608, may include causing output of the speech represented by the audio data. For instance, the system(s) may cause, such as by using one or more output devices and/or components, the output of the speech as represented by the audio data 128.

### Example Computing Device

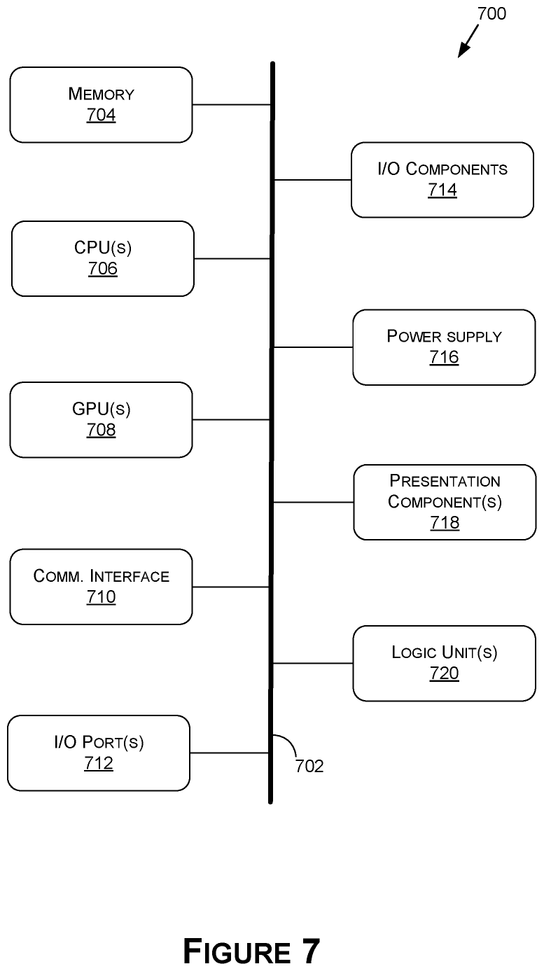

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

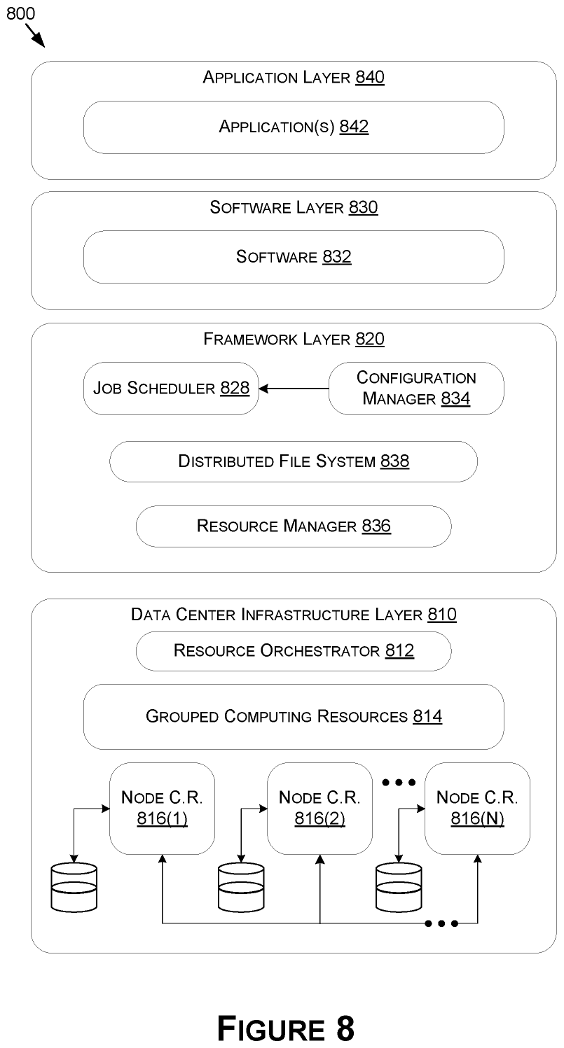

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining an identity associated with a speaker, text associated with a target language, and an accent associated with the target language;
generating, using one or more models and based at least on the identity associated with the speaker, the text associated with the target language, and the accent associated with the target language, audio data representative of speech associated with the text and in the target language; and
causing output of the speech represented by the audio data.

2. The method of claim 1, further comprising:
determining, using the one or more models and based at least on the identity associated with the speaker, the text associated with the target language, and the accent associated with the target language, one or more features associated with the speech,
wherein the generating the audio data is based at least on the one or more features associated with the speech.

3. The method of claim 2, wherein the one or more features associated with the speech comprise one or more of:
one or more energies associated with the speech;
one or more frequencies associated with the speech; or
one or more phoneme durations associated with the speech.

4. The method of claim 1, further comprising:
determining, based at least on the identity associated with the speaker, one or more speech characteristics associated with a voice of the speaker,
wherein the generating the audio data is based at least on the one or more speech characteristics, the text associated with the target language, and the accent associated with the target language.

5. The method of claim 4, wherein the one or more speech characteristics associated with the voice of the speaker are learned by disentangling an additional accent from additional speech made by the speaker in an additional language.

6. The method of claim 1, wherein the accent associated with the target language is learned by processing additional audio data representative of additional speech from one or more additional speakers, the additional speech being in the target language.

7. The method of claim 1, further comprising:
generating, based at least on the text associated with the target language, an alignment between one or more embeddings associated with the text and one or more phonemes,
wherein the generating the audio data is based at least on the identity associated with the speaker, the alignment between the one or more embeddings and the one or more phonemes, and the accent associated with the target language.

8. The method of claim 7, wherein the generating the alignment between the one or more embeddings and the one or more phonemes is further based at least on the accent associated with the target language.

9. The method of claim 1, wherein the generating the audio data comprises:
generating, using a decoder of the one or more models and based at least on the identity associated with the speaker, the text associated with the target language, and the accent associated with the target language, one or more spectrograms associated with the speech; and
generating, using a vocoder of the one or more models and based at least on the one or more spectrograms, the audio data representative of the speech in the target language.

10. The method of claim 1, wherein the speech preserves at least one of a voice associated with the speaker or a timbre associated with the speaker.

11. The method of claim 1, wherein the generating the audio data is performed without additional audio data associated with the speaker in the target language.

12. A system comprising:
one or more processing units to:
determine one or more variables associated with generating speech in a target language;
determine, using one or more models and based at least on the one or more variables, one or more features associated with the speech;
determining, using the one or more models and based at least on the one or more features, audio data representative of the speech in the target language; and
cause output of speech represented by the audio data.

13. The system of claim 12, wherein the one or more features associated with the speech comprise one or more of:
one or more energies associated with the speech;
one or more frequencies associated with the speech; or
one or more phoneme durations associated with the speech.

14. The system of claim 12, wherein the one or more variables associated with generating the speech in the target language comprise one or more of:
an identity associated with a speaker;
text associated with the target language; or
an accent associated with the target language.

15. The system of claim 12, wherein:
the one or more variables associated with generating the speech in the target language comprise at least an identity associated with a speaker;
the one or more processing units are further to determine, based at least on the identity associated with the user, one or more speech characteristics associated with a voice of the user,
the audio data representative of the speech is further generated based at least on the one or more speech characteristics associated with the voice of the user.

16. The system of claim 15, wherein the one or more speech characteristics associated with the voice of the speaker are learned by disentangling an additional accent from additional speech made by the speaker in an additional language.

17. The system of claim 12, wherein:
the one or more variables associated with generating the speech in the target language comprise at least an accent associated with the target language; and
the audio data representative of the speech is further generated based at least on the accent associated with the target language.

18. The system of claim 12, wherein:
the one or more variables associated with generating the speech in the target language comprise at least an alignment between one or more embeddings associated with text and one or more phonemes, the speech being associated with the text; and
the one or more processing units are further to determine the alignment between the one or more embeddings and the one or more phonemes based at least on an accent associated with the target language.

19. The system of claim 12, wherein the generation of the audio data comprises:
generating, using a decoder of the one or more models and based at least on the one or more features, one or more spectrograms associated with the speech; and
generating, using a vocoder of the one or more models and based at least on the one or more spectrograms, the audio data representative of the speech in the target language.

20. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing voice conferencing;
a system implementing a gaming application;
a system for generating synthetic data;
a system implementing one or more large language models (LLMs);
a system incorporating one or more virtual machines (VMs);
a system implemented at least partially in a data center; or
a system implemented at least partially using cloud computing resources.

21. A processor comprising:
one or more processing units to generate audio data representative of speech in a first language, wherein the audio data is generated based at least on an identity associated with a user, text that is translated from a second language associated with the user to the first language, and an accent associated with the first language.

22. The processor of claim 20, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing voice conferencing;
a system implementing a gaming application;
a system for generating synthetic data;
a system implementing one or more large language models (LLMs);
a system incorporating one or more virtual machines (VMs);
a system implemented at least partially in a data center; or
a system implemented at least partially using cloud computing resources.
